(19) United States
(12) Patent Application Publication
(10) Pub. No.: US 2012/0032913 A1
(43) Pub. Date: Feb. 9, 2012

(54) DISPLAY APPARATUS AND METHOD FOR MANUFACTURING PARALLAX BARRIER TOUCH BOARD

(75) Inventors: Wei-tong Shih, Wugu (TW); Chih-hung Tsai, Wugu (TW); Di-jie Chang, Wugu (TW); Wen-chi Lin, Wugu (TW)

(73) Assignee: HANNSTAR DISPLAY CORPORATION, Wugu (TW)

(21) Appl. No.: 13/078,925

(22) Filed: Apr. 1, 2011

(30) Foreign Application Priority Data
Aug. 5, 2010 (TW) 099126136

(51) Int. Cl. G06F 3/044; B05D 5/12; G06F 3/041

(52) U.S. Cl. 345/174; 345/173; 427/97.1

(57) ABSTRACT

A display apparatus and a method for manufacturing a parallax barrier touch board are disclosed. The display apparatus comprises a display panel and the parallax barrier touch board. The method for manufacturing the parallax barrier touch board comprises the following steps: forming a barrier layer on a substrate, wherein the barrier layer includes a plurality of parallax barriers; and forming a touch sensing circuit layer on the parallax barrier.

### FIELD OF THE INVENTION

The present invention relates to a display apparatus and a method for manufacturing a parallax barrier touch board, and more particularly, to a display apparatus using the parallax barrier touch board to achieve a touch control function and a three-dimensional (3D) image display function.

### BACKGROUND OF THE INVENTION

Currently, a display apparatus may have many functions, such as a displaying function, a touch control function and a three-dimensional (3D) image displaying function. In general, a multi-functional display has to add an addition of functional panel for achieving various functionalities. For example, a touch panel or a parallax barrier panel has to be added for achieving a touch control function or a 3D image display function.

However, a display with multi-functions needs a cover lens to cover and protect the functional panel (such as the parallax barrier panel). Therefore, the additional functional panel needs to have at least one glass substrate and the cover lens added thereon, hence adding a thickness, weight and material cost to the display.

Another way for achieving the multi-functional display is to integrate the functional panel into a display panel thereof. For example, a touch controlling circuit or a parallax barrier can be integrated into a color filter (CF) substrate or a thin film transistor (TFT) substrate. However, the integrated multi-functional panel has problems of low process yield and high cost, and the processing steps thereof are complicated. Furthermore, when the display panel or the functional device (such as the touch controlling circuit or the parallax barrier) thereof has issues or fails to work, the integrated multi-functional display can be difficult to rework or repair.

### SUMMARY OF THE INVENTION

Therefore, an aspect of the present invention is to provide a display apparatus and a method for manufacturing a parallax barrier touch board, thereby using the parallax barrier touch board to achieve a touch control function and a 3D image display function.

According to an embodiment of the present invention, the display apparatus comprises a display panel and a parallax barrier touch board. The parallax barrier touch board comprises a substrate, a barrier layer and a touch sensing circuit layer. The barrier layer is formed on the substrate and includes a plurality of parallax barriers. The touch sensing circuit layer is formed on the barrier layer.

In one embodiment of the present invention, the barrier layer further includes a peripheral barrier pattern formed around the substrate.

In one embodiment of the present invention, the display apparatus further comprises a cover lens disposed on the parallax barrier touch board, wherein the cover lens includes a peripheral barrier pattern formed around the cover lens.

In one embodiment of the present invention, the display panel is a liquid crystal display (LCD) panel, an organic light emission diode (OLED) panel, a plasma display panel (PDP) or a field emission display panel.

In one embodiment of the present invention, the touch sensing circuit layer is a capacitive touch sensing circuit layer.

In one embodiment of the present invention, the touch sensing circuit layer is a resistive touch sensing circuit layer.

In one embodiment of the present invention, the parallax barrier touch board is bonded on the display panel by an optical adhesive.

According to another embodiment of the present invention, the method for manufacturing a parallax barrier touch board comprises the following steps: forming a barrier layer on a substrate, wherein the barrier layer includes a plurality of parallax barriers; and forming a touch sensing circuit layer on the barrier layer.

In one embodiment of the present invention, the touch sensing circuit layer comprises a transparent conductive film, an insulating layer, a plurality of metal wires and a transparent passvation layer formed in sequence on the barrier layer.

Therefore, with the use of the parallax barrier touch board of the display apparatus disclosed in the embodiments of the present invention, the touch control function and the 3D image display function can be integrated into the display apparatus, thereby reducing the weight, thickness and cost thereof. Furthermore, the processing steps of a display apparatus can be simplified, and the display panel or the parallax barrier touch board thereof can be easily reworked or repaired.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram showing a display apparatus according to a first embodiment of the present invention;

FIG. 2 is a partially cross-section view showing the display apparatus according to the first embodiment of the present invention;

FIG. 3 is a flow diagram showing a method for manufacturing the parallax barrier touch board according to a first embodiment of the present invention; and

FIG. 4 is a partially cross-section view showing the display apparatus according to a second embodiment of the present invention.

### DETAILED DESCRIPTION OF THE PREFERRED EMBODIMENT

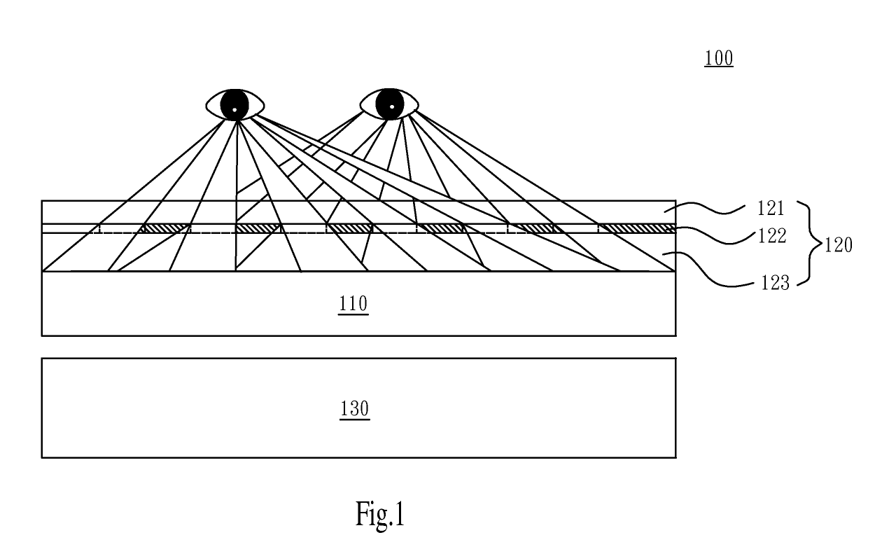

In order to make the illustration of the present invention more explicit and complete, the following description is stated with reference to FIG. 1 through FIG. 4.

In the drawings, like reference numerals indicate like components or items.

Referring to FIG. 1, a schematic diagram showing a display apparatus according to a first embodiment of the present invention is illustrated. The display apparatus 100 of the present embodiment may have a touch control function and a three-dimensional (3D) image display function. That is, the display apparatus 100 can sense the touch of a user's fingers or other objects and output corresponding signals, and the display apparatus 100 can display a 3D image. The display apparatus 100 may comprise a display panel 110 and a parallax barrier touch board 120.

Referring to FIG. 1 again, the display panel 110 may be a liquid crystal display (LCD) panel, an organic light emission diode (OLED) panel, a plasma display panel (PDP) or a field emission display panel for displaying a two-dimensional (2D) image. In the present embodiment, the display panel 110 may be the LCD panel. At this time, the display apparatus 100 may further comprise a backlight module 130 for providing a backlight to the display panel 110 (LCD panel).

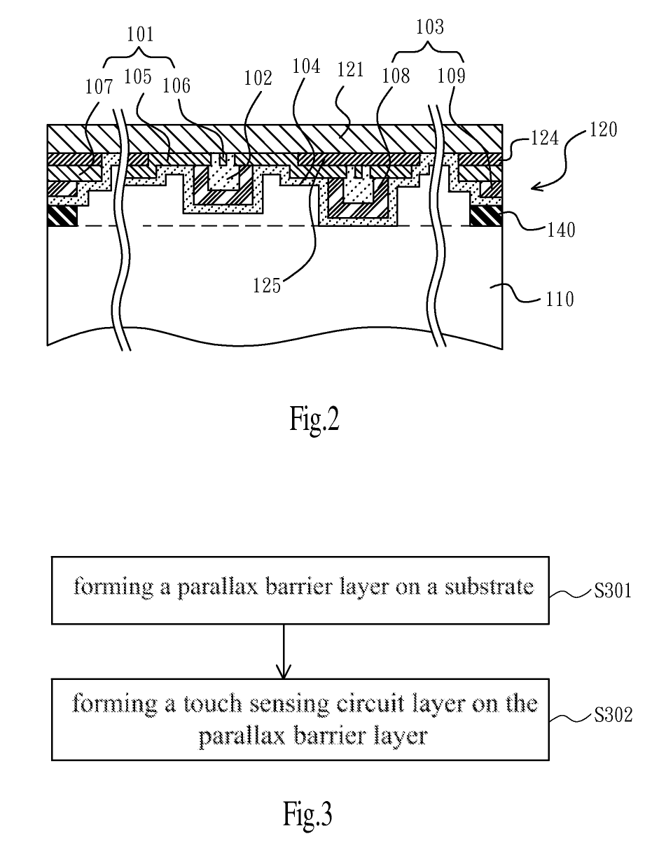

Referring to FIG. 1 and FIG. 2, FIG. 2 is a partially cross-section view showing the display apparatus according to the first embodiment of the present invention. The parallax barrier touch board 120 comprises a substrate 121, a barrier layer 122 and a touch sensing circuit layer 123. The substrate 121 may be a glass substrate or a flexible transparent substrate, and the material thereof may be glass, polycarbonate (PC), polyethylene terephthalate (PET), polymethylmethacrylate (PMMA), cyclic olefin copolymer (COC) or polyether sulfone (PES). In the present embodiment, the substrate 121 preferably has a great strength of material to be a protection substrate for protecting the parallax barrier touch board 120 and the display panel 110 from harm. The barrier layer 122 is formed on one side of the display panel 110 for sheltering light. The material of the barrier layer 122 may be metal (such as Cr), metallic oxide, graphite and resin material. The barrier layer 122 includes a peripheral barrier pattern 124 and a plurality of parallax barriers 125. The peripheral barrier pattern 124 is formed around the substrate 121 and corresponds to a non-displaying region of the display apparatus 100 for sheltering light therein. The parallax barriers 125 are formed inside the peripheral barrier pattern 124 for forming a 3D image effect. The parallax barriers 125 are arranged periodically, and there is a predetermined interval between each adjacent two of the parallax barriers 125 to allow light passing through the barrier layer 122. Therefore, the parallax barriers 125 of the barrier layer 122 can form the light barriers spaced at intervals. By using the parallax barriers 125 of the barrier layer 122, the user's eyes can respectively see the pixels at different positions of the display panel 110, thereby forming a visual effect of watching a 3D image.

Referring to FIG. 2 again, the touch sensing circuit layer 123 of the present embodiment may be a capacitive touch sensing circuit layer for sensing the touch or moving of the finger or object. The touch sensing circuit layer 123 includes a transparent conductive film 101, an insulating layer 102, a plurality of metal wires 103 and a transparent passvation layer 104. The transparent conductive film 101 may be made of a transparent conductive material, such as ITO, IZO, AZO, ATO, GZO, TCO, ZnO or PEDOT. The transparent conductive film 101 is formed on the substrate 121 and partially covers the barrier layer 122. The transparent conductive film 101 includes a plurality of sensing pads 105, a plurality of transparent connecting structures 106 and a plurality of transparent guiding wires 107. The sensing pads 105 are arranged inside the peripheral barrier pattern 124 in a matrix form for sensing the touch or moving of the object. The shape of the sensing pads 105 may be rhombus or polygon. The transparent connecting structures 106 are disposed between the sensing pads 105 for electrically connecting the sensing pads 105 along a first direction. The transparent guiding wires 107 are disposed on the peripheral barrier pattern 124 for outputting sensing signals. The insulating layer 102 may be made of a transparent insulating material and cover the transparent connecting structures 106 of the transparent conductive film 101 for electrically isolating the sensing pads 105 at different directions. For example, the sensing pads 105 along the first direction can be isolated from the sensing pads 105 along the second direction, wherein the second direction is different to the first direction. For example, the second direction is vertical to the first direction. The metal wires 103 include a plurality of metal connecting structures 108 and a plurality of metal guiding wires 109. The metal connecting structures 108 are formed on the insulating layer 102 for electrically connecting the sensing pads 105 along the second direction. The metal guiding wires 109 are disposed on the transparent guiding wires 107 for outputting sensing signals. The transparent passvation layer 104 cover the transparent conductive film 101, insulating layer 102 and the metal wires 103 for protecting them. The transparent passvation layer 104 may be made of a transparent insulating material, such as silica (SiO₂).

It is worth mentioning that the touch sensing circuit layer 123 is not limited to the above-mentioned sensing structure. For example, the touch sensing circuit layer 123 can be a resistive touch sensing circuit layer.

Referring to FIG. 3, a flow diagram showing a method for manufacturing the parallax barrier touch board according to a first embodiment of the present invention is illustrated. When manufacturing the parallax barrier touch board 120 of the present embodiment, in the step S301, the barrier layer 122 is formed on the substrate 121. The peripheral barrier pattern 124 and the parallax barriers 125 of the barrier layer 122 can be formed at the inside of the substrate 121 by a photolithographic process. Subsequently, in the step S302, the touch sensing circuit layer 123 is formed on the barrier layer 122. When forming the touch sensing circuit layer 123 on the barrier layer 122, the transparent conductive film 101, the insulating layer 102, the metal wires 103 and the transparent passvation layer 104 are formed in sequence on the barrier layer 122 for forming the touch sensing circuit layer 123 thereon, and thus the parallax barrier touch board 120 can be formed. When assembling the display apparatus 100 of the present embodiment, the parallax barrier touch board 120 can be bonded on the display panel 110 by using an optical adhesive 140 for sensing the touch or moving of the finger or object and forming the parallax barrier to generate a 3D image effect. In the present embodiment, the barrier layer 122 and the touch sensing circuit layer 123 of the parallax barrier touch board 120 are disposed between the substrate 121 and the display panel 110.

Therefore, the display apparatus 100 of the present embodiment can utilize the parallax barrier touch board 120 to achieve the touch control function and the 3D image display function. When the display apparatus 100 performs the touch control function, the finger or object can touch the substrate 121 of the parallax barrier touch board 120, and the touch or moving thereof can be detected by the touch sensing circuit layer 123 for obtaining the touch controlling effect. When the display apparatus 100 performs the 3D image display function, the user's eyes can respectively watch different images by using the parallax barriers 125 of the parallax barrier touch board 120, thereby forming a 3D image effect with depth perception.

Since the touch control function and the 3D image display function are integrated into the parallax barrier touch board 120 of the display apparatus 100, the use of the glass in the display apparatus 100 can be reduced, thereby reducing the weight, thickness and cost thereof. Furthermore, the touch sensing circuit layer 123 of the parallax barrier touch board 120 can be directly formed on the barrier layer 122, and thus the process steps thereof can be simplified. Besides, the display apparatus 100 is composed of the display panel 110 and the parallax barrier touch board 120. Therefore, when the display panel 110 or the parallax barrier touch board 120 has issues or fails, the display panel 110 or the parallax barrier touch board 120 can be reworked or repaired, individually.

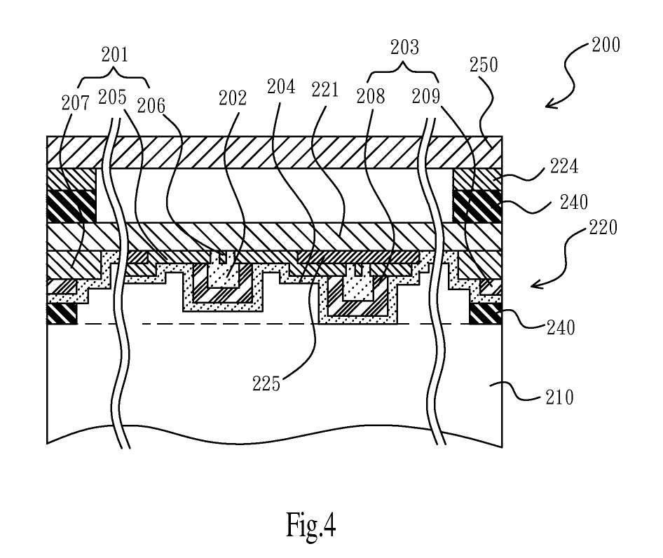

Referring to FIG. 4, a partially cross-section view showing the display apparatus according to a second embodiment of the present invention is illustrated. In the second embodiment, the display apparatus 200 comprises a display panel 210, a parallax barrier touch board 220 and a cover lens 250. The display panel 210 may be a LCD panel for displaying the 2Ds image. The parallax barrier touch board 220 may be disposed between the display panel 210 and the cover lens 250. The cover lens 250 is disposed on the parallax barrier touch board 220 for protecting the parallax barrier touch board 220.

Referring to FIG. 4 again, the parallax barrier touch board 220 comprises a substrate 221, a barrier layer 222 and a touch sensing circuit layer 223. The barrier layer 222 and the touch sensing circuit layer 223 are formed in sequence on the substrate 221. The barrier layer 222 includes a plurality of parallax barriers 225 formed in a displaying region of the display apparatus 200 for forming the 3D image effect. The touch sensing circuit layer 223 includes a transparent conductive film 201, an insulating layer 202, a plurality of metal wires 203 and a transparent passvation layer 204 formed in sequence on the barrier layer 222. The transparent conductive film 201 includes a plurality of sensing pads 205, a plurality of transparent connecting structures 206 and a plurality of transparent guiding wires 207. The insulating layer 202 covers the transparent connecting structures 206 of the transparent conductive film 201. The metal wires 203 include a plurality of metal connecting structures 208 and a plurality of metal guiding wires 209. The transparent passvation layer 204 covers the transparent conductive film 201, the insulating layer 202 and the metal wires 203.

Referring to FIG. 4 again, in the second embodiment, the cover lens 250 includes a peripheral barrier pattern 224 formed on the surrounding thereof and corresponding to the non-displaying region of the display apparatus 200 for sheltering light therein. The material of the cover lens 250 is preferably glass or plastics with high strength. The cover lens 250 can be bonded on the parallax barrier touch board 220 by an optical adhesive 140.

As described above, the display apparatus of the present invention can utilize the parallax barrier touch board to achieve the touch control function and the 3D image display function. Since the touch control function and the 3D image display function are integrated into the parallax barrier touch board, the use of the glass in the display apparatus can be reduced for reducing the weight, thickness and cost thereof, and the process steps thereof can be simplify. Furthermore, since the display apparatus is composed of the display panel and the parallax barrier touch board, the display panel or the parallax barrier touch board can be easy to be reworked or repaired, individually.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A display apparatus comprising:
a display panel; and
a parallax barrier touch board comprising:
a substrate;
a barrier layer formed on the substrate and including a plurality of parallax barriers; and
a touch sensing circuit layer formed on the barrier layer.

2. The display apparatus as claimed in claim 1, wherein the barrier layer further includes a peripheral barrier pattern formed around the substrate.

3. The display apparatus as claimed in claim 1, further comprising:
a cover lens disposed on the parallax barrier touch board, wherein the cover lens includes a peripheral barrier pattern formed around the cover lens.

4. The display apparatus as claimed in claim 1, wherein the display panel is a liquid crystal display (LCD) panel, an organic light emission diode (OLED) panel, a plasma display panel (PDP) or a field emission display panel.

5. The display apparatus as claimed in claim 1, wherein the touch sensing circuit layer is a capacitive touch sensing circuit layer.

6. The display apparatus as claimed in claim 1, wherein the touch sensing circuit layer is a resistive touch sensing circuit layer.

7. The display apparatus as claimed in claim 1, wherein the parallax barrier touch board is bonded on the display panel by an optical adhesive.

8. A method for manufacturing a parallax barrier touch board comprising the following steps:
forming a barrier layer on a substrate, wherein the barrier layer includes a plurality of parallax barriers; and
forming a touch sensing circuit layer on the barrier layer.

9. The method as claimed in claim 8, wherein the barrier layer further includes a peripheral barrier pattern formed around the substrate.

10. The method as claimed in claim 8, wherein the touch sensing circuit layer comprises a transparent conductive film, an insulating layer, a plurality of metal wires and a transparent passvation layer formed in sequence on the barrier layer.
